(19) United States
(12) Patent Application Publication
(10) Pub. No.: US 2013/0052416 A1
(43) Pub. Date: Feb. 28, 2013

(54) STOPPER FOR MAGNETIC HEAD

(71) Applicant: Takamitsu WADA, Hirakata-shi (JP)

(72) Inventor: Takamitsu WADA, Hirakata-shi (JP)

(73) Assignee: Yamauchi Corporation, Hirakata-shi (JP)

(21) Appl. No.: 13/594,958

(22) Filed: Aug. 27, 2012

(30) Foreign Application Priority Data
Aug. 26, 2011 (JP) 2011-184745

(51) Int. Cl. G11B 5/62

(52) U.S. Cl. 428/141

(57) ABSTRACT

A stopper for a magnetic head is capable of coming into contact with a locking portion formed on an arm having a magnetic head, has surface roughness (Rz) of at least 1 μm and not more than 6.5 μm, and is made of a polyurethane-based elastomer composition. This polyurethane-based elastomer preferably contains a polyurethane elastomer consisting of diisocyanate and adipate-based polyol.

This nonprovisional application is based on Japanese Patent Application No. 2011-184745 filed on Aug. 26, 2011 with the Japan Patent Office, the entire contents of which are hereby incorporated by reference.

### BACKGROUND OF THE INVENTION

1. Field of the Invention

The present invention relates to a stopper for a magnetic head (may hereinafter be simply referred to as “stopper”), and more particularly, it relates to a stopper made of a polyurethane-based elastomer composition.

2. Description of the Background Art

A stopper provided on a magnetic recording apparatus or the like regulates the quantity of rotation of an arm having a magnetic head. The arm is rotatable on a point in the longitudinal direction thereof, and has the magnetic head and a locking portion on first and second ends in the longitudinal direction respectively. The locking portion comes into contact with the stopper, thereby regulating rotation of the arm. The arm returns to the original position when recording or reproduction of data is terminated. Therefore, adhesion of the stopper to the locking portion must be optimized (for example, refer to Japanese Patent Laying-Open No. 2006-40373).

The magnetic recording apparatus generates heat during operation. Therefore, a stopper having high shock-absorbing characteristics and stable load displacement in a wide temperature range has been proposed (for example, refer to Japanese Patent Laying-Open No. 2005-281655). Further, the magnetic recording apparatus generates an outgas when the inner part thereof is exposed to a heat environment, and hence a stopper capable of preventing generation of an outgas also when the inner part of a magnetic recording apparatus is exposed to a heat environment has been proposed (for example, refer to Japanese Patent Laying-Open No. 2001-288241).

### SUMMARY OF THE INVENTION

An object of the present invention is to provide a stopper for a magnetic head excellent in moldability and reduced in manufacturing cost while reducing a compression set, reducing adhesion to a locking portion and preventing cracking resulting from operation of an arm.

The stopper for a magnetic head according to the present invention is capable of coming into contact with a locking portion formed on an arm having a magnetic head, has surface roughness (Rz) of at least 1 μm and not more than 6.5 μm, and is made of a polyurethane-based elastomer composition.

The polyurethane-based elastomer composition preferably contains a polyurethane elastomer consisting of diisocyanate and adipate-based polyol, and preferably has JIS-A hardness of at least 90 and not more than 98.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a magnetic recording apparatus according to an embodiment of the present invention;

FIG. 2 is a horizontal sectional view of a stopper mechanism shown in FIG. 1;

FIG. 3 is a vertical sectional view of the stopper mechanism shown in FIG. 1; and

FIG. 4 is a plan view for illustrating a method of measuring adhesion torque in stoppers according to Examples of the present invention and comparative examples.

### DESCRIPTION OF THE PREFERRED EMBODIMENTS

A stopper for a magnetic head according to the present invention is now described with reference to the accompanying drawings. Referring to the drawings, identical reference signs show the same or corresponding portions. Dimensions such as lengths, widths, thicknesses and depths are properly changed in order to clarify and simplify the drawings, and do not express actual dimensions.

<Stopper for Magnetic Head>

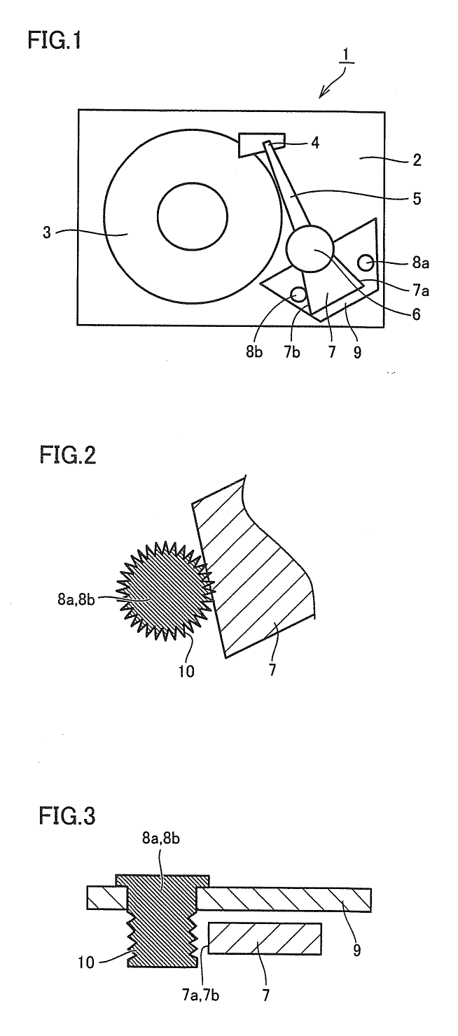

The stopper for a magnetic head according to the present invention is provided on a magnetic recording apparatus or the like, and regulates rotation of an arm having a magnetic head. Further, the stopper according to the present invention has surface roughness Rz of at least 1 μm and not more than 6.5 μm, and is made of a polyurethane-based elastomer composition. General functions etc. of the stopper are now described by describing the structure of a magnetic recording apparatus 1 with reference to FIGS. 1 to 3, followed by description of the surface roughness Rz etc. of the stopper according to the present invention. Each of inner and outer stoppers 8a and 8b shown in FIGS. 1 to 3 corresponds to the stopper according to the present invention. The structure of the magnetic recording apparatus provided with the stopper according to the present invention is not restricted to that shown in FIG. 1.

In magnetic recording apparatus 1, a magnetic disk 3 serving as a recording medium for data and an arm 5 are arranged on a base portion 2. Arm 5, rotating on a rotation axis 6, has a magnetic head 4 on a forward end portion thereof. Magnetic head 4 records and reproduces data in and from magnetic disk 3.

Arm 5 is provided on a side of rotation axis 6 opposite to magnetic head 4 with a locking portion 7, which constitutes a stopper mechanism along with inner and outer stoppers 8a and 8b. Inner and outer stoppers 8a and 8b are held by a voice coil motor 9 provided on locking portion 7, and provided on positions regulating the quantity of movement of arm 5 in a prescribed range. More specifically, an inner-side contact surface 7a of locking portion 7 comes into contact with inner stopper 8a when arm 5 rotates to move in a direction where magnetic head 4 approaches magnetic disk 3, thereby inhibiting arm 5 from further rotation (regulation of rotation of arm 5). When arm 5 rotates to move in a direction where magnetic head 4 separates from magnetic disk 3, on the other hand, an outer-side contact surface 7b of locking portion 7 comes into contact with outer stopper 8b as shown in FIG. 1, thereby inhibiting arm 5 from further rotation.

The surface roughness Rz, JIS-A hardness and the polyurethane-based elastomer composition are now described in order. In the following <Surface Roughness Rz> and <JIS-A Hardness>, inner and outer stoppers 8a and 8b may not be distinguished from each other and hence the same are collectively simply referred to as “stopper 8a”, while inner-side and outer-side contact surfaces 7a and 7b may not be distinguished from each other either and hence the same are collectively simply referred to as “contact surface 7a”. In the following <Polyurethane-Based Elastomer Composition>, the composition may not be described with reference to the drawings and hence stopper 8a is simply referred to as “stopper” or the like with no reference sign.

<Surface Roughness Rz>

Irregularities 10 are formed on the surface of stopper 8a, as shown in FIGS. 2 and 3. Thus, stopper 8a has surface roughness Rz of at least 1 μm and not more than 6.5 μm. The surface roughness Rz corresponds to the maximum height of irregularities, and is measured according to JIS B 0601:2001.

Stopper 8a comes into contact with contact surface 7a of locking portion 7, which is generally smooth. If the surface roughness Rz of stopper 8a is less than 1 μm, therefore, adhesive strength of stopper 8a with respect to contact surface 7a of locking portion 7 may be excessive. In this case, arm 5 may not be returnable to the original position even if recording or reproduction of data is terminated, leading to a malfunction or the like of magnetic recording apparatus 1. Further, arm 5 may return to the original position while stopper 8a partially adheres to contact surface 7a of locking portion 7, to result in breakage of stopper 8a.

If the surface roughness Rz of stopper 8a exceeds 6.5 μm, on the other hand, mold releasability is reduced. More specifically, it is difficult to detach (release) molded stopper 8a from a mold, and irregularities 10 may be broken in mold releasing.

When the surface roughness Rz of stopper 8a is at least 1 μm and not more than 6.5 μm, however, arm 5 can be returned to the original position without breaking stopper 8a upon termination of recording or reproduction of data, and magnetic recording apparatus 1 can be prevented from a malfunction or the like. Further, reduction of mold releasability can be prevented (irregularities 10 can be prevented from breakage in mold releasing).

The lower and upper limits of the surface roughness Rz of stopper 8a are preferably 1.7 μm and 4.5 μm respectively. When the surface roughness Rz of stopper 8a is at least 1.7 μm and not more than 4.5 μm, mold releasability can be improved (molded stopper 8a can be easily detached from the mold).

Adhesive strength of stopper 8a with respect to contact surface 7a of locking portion 7 is measured according to an adhesion torque test or the like described later with reference to Examples. When the measured adhesion torque is not more than 0.8 mNm, more preferably not more than 0.3 mNm, arm 5 can be returned to the original position upon termination of recording or reproduction of data, and magnetic recording apparatus 1 can be prevented from a malfunction or the like.

Irregularities 10 may not be formed on the overall surface of stopper 8a, but may simply be formed on a portion, with which contact surface 7a of locking portion 7 comes into contact, of the surface of stopper 8a. In other words, the surface roughness Rz of the overall surface of stopper 8a may not be at least 1 μm and not more than 6.5 μm, but that of the portion, with which contact surface 7a of locking portion 7 comes into contact, of the surface of stopper 8a may simply be at least 1 μm and not more than 6.5 μm. Thus, the aforementioned effects (arm 5 can be returned to the original position without breaking stopper 8a upon termination of recording or reproduction of data and reduction of mold releasability can be prevented) can be attained.

Stopper 8a is made of the polyurethane-based elastomer composition, which is a thermoplastic resin material. Therefore, stopper 8a can be molded by injection molding. For example, stopper 8a can be molded with a mold having prescribed surface roughness (for example, surface roughness of at least 3 μm and not more than 6 μm) Rz. The surface roughness Rz of the mold is also measured according to JIS B 0601:2001.

<JIS-A Hardness>

Stopper 8a preferably has JIS-A hardness of at least 90 and not more than 98, and more preferably has JIS-A hardness of at least 92 and not more than 98. If the JIS-A hardness of stopper 8a is less than 90, stopper 8a may be remarkably deformed when locking portion 7 comes into contact with stopper 8a (hereinafter simply referred to as “in contact”). Therefore, a compression set and a modulus of repulsion elasticity of stopper 8a may be so increased that the magnetic head falls to allow no reading/writing of data. If the JIS-A hardness of stopper 8a exceeds 98, on the other hand, stopper 8a may hardly absorb energy caused in contact, leading to inconvenience such as occurrence of an impulsive sound or noise. When stopper 8a has JIS-A hardness of at least 90 and not more than 98, however, the compression set and the modulus of repulsion elasticity of stopper 8a are reduced, and data can be stably read/written.

The compression set of stopper 8a, measured according to ASTM D-395 (JIS K 6262), is preferably not more than 40%, and more preferably not more than 30%. If the compression set of stopper 8a exceeds 40%, permanent deformation of stopper 8a cannot be ignored, leading to inconvenience such as occurrence of flex deformation resulting from contact.

The modulus of repulsion elasticity of stopper 8a, measured according to JIS K 6255, is preferably not more than 40%, and more preferably not more than 30%. If the modulus of repulsion elasticity of stopper 8a exceeds 40%, energy absorbed by stopper 8a in contact is so excessively increased that the magnetic head falls to allow no reading/writing of data.

<Polyurethane-Based Elastomer Composition>

The polyurethane-based elastomer composition employed in the present invention preferably contains a polyurethane elastomer consisting of diisocyanate and polyol. The diisocyanate preferably has an aromatic group to which an alkylene group is bonded. The polyol is preferably adipate-based polyol. The aforementioned polyurethane elastomer is obtained due to condensation reaction caused by mixing the diisocyanate and the adipate-based polyol with each other. Therefore, the molar ratios of the diisocyanate and the adipate-based polyol may be set in response to the number of OH groups in the adipate-based polyol.

According to the present invention, the polyurethane-based elastomer composition is obtained by mixing and reacting the diisocyanate having the aromatic group to which the alkylene group is bonded and the adipate-based polyol with each other, whereby the cost for the polyurethane-based elastomer composition can be suppressed. Therefore, the stopper according to the present invention can be provided at a low cost. Further, moldability of the stopper according to the present invention is improved due to high strength/physical properties of the materials. In addition, the content of a mold release agent can be suppressed due to the high moldability. Therefore, the quantity of generation of an outgas in the magnetic recording apparatus during operation can be reduced.

The moldability of the stopper is determined as follows: When a stopper is molded while setting a time for cooling performed for detaching the molded stopper from the mold to less than 40 seconds, more preferably less than 30 seconds and the obtained stopper has no defects in appearance, the stopper is determined as excellent in moldability.

As to the quantity of generation of an outgas, the quantity (concentration) of the outgas generated from the stopper exposed to a heat environment may be measured according to gas chromatography. When the concentration of an outgas component is not more than 120 ppm and more preferably not more than 80 ppm, the stopper is determined as reduced in the quantity of generation of the outgas.

<Diisocyanate>

The diisocyanate preferably has an aromatic group to which an alkylene group is bonded, and is preferably methylene bis(4,1-phenylene)diisocyanate (hereinafter abbreviated as “MDI”) or xylylene diisocyanate, for example.

<Adipate-Based Polyol>

The adipate-based polyol, which is a compound obtained by dehydration polycondensation reaction of adipic acid and polyvalent alcohol or glycol, preferably also contains adipic acid.

The polyurethane-based elastomer composition employed in the present invention may contain a mold release agent to such an extent that the quantity of generation of an outgas does not exceed 120 ppm. Thus, the mold releasability can be further improved.

### EXAMPLES

While the stopper according to the present invention is now described in more detail with reference to Examples and comparative examples, the present invention is not restricted to the following Examples.

### Examples 1 to 3 and Comparative Examples 1 and 2

Stoppers according to Examples 1 to 3 and comparative examples 1 and 2 were prepared by employing molds different in surface roughness from each other, to examine surface roughness values, mold releasability values, adhesion torque values, hardness values, compression sets, moduli of repulsion elasticity and quantities of generated outgases in the stoppers.

<Preparation of Stopper>

Polyurethane-based elastomer compositions were obtained by employing materials shown in Table 1. The obtained polyurethane-based elastomer compositions were heated to 220° C. and injected into prescribed molds (made of metals) by resin injection molding with a side gate. When the polyurethane-based elastomer compositions were cooled to room temperature, the molded stoppers were detached from the molds.

The molds had surface roughness values shown in Table 1 respectively. Therefore, irregularities of the molds were transferred to the molded stoppers. The surface roughness values of the molds shown in Table 1 were measured according to JIS B 0601:2001.

<Measurement of Surface Roughness>

The surface roughness values of the stoppers were measured according to JIS B 0601:2001. Table 1 shows the results.

<Evaluation of Mold Releasability>

The stoppers detached from the molds were visually observed, to examine the presence or absence of defectives in appearance. Referring to “Mold Releasability” in Table 1, “A1” denotes that no defects in appearance were confirmed, and “C1” denotes that defects in appearance such as protrusion or separation of surfaces were confirmed.

<Measurement of Adhesion Torque>

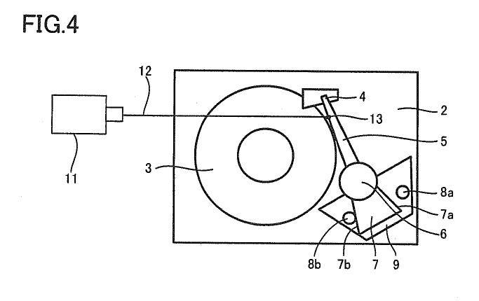

First, locking portions were brought into contact with the stoppers, which in turn were left in environments of 0° C. and 80° C. for two hours respectively. These operations were repeated by 15 cycles. Thereafter peel force of each outer stopper 8b was confirmed by coupling the forward end of a torque gauge 11 and magnetic head 4 with each other by a wire 12, as shown in FIG. 4. Adhesion torque of each stopper was calculated with reference to the distance from rotation axis 6 to a joint 13 between magnetic head 4 and wire 12 and the peel force. Table 1 shows the results.

<Measurement of Hardness>

Hardness values (JIS-A hardness values) of the stoppers were measured according to JIS K 6253. Table 1 shows the results.

<Measurement of Compression Set>

The compression sets of the stoppers were measured according to ASTM D-395 (JIS K 6262). Table 1 shows the results. The stoppers caused less permanent deformation as the compression sets were reduced.

<Measurement of Modulus of Repulsion Elasticity>

Moduli of repulsion elasticity of the stoppers were measured according to JIS K 6255. Table 1 shows the results. The stoppers exhibited smaller absorption energy values in contact as the moduli of repulsion elasticity were reduced.

<Measurement of Quantity of Generated Outgas>

The stoppers were exposed to a temperature of 150° C. in a closed chamber. Generated outgases were adsorbed to activated charcoals, and outgas components were heat-extracted from the activated charcoals in another chamber, and condensed in glass wool. The concentrated outgas components were determined by gas chromatography/mass spectrometry. Table 1 shows the results.

TABLE 1

| | Compar- | | | | Compar- |
|---|---|---|---|---|---|
| | ative | | | | ative |
| | Example 1 | Example 1 | Example 2 | Example 3 | Example 2 |
| Polyol | Adipate- | Adipate- | Adipate- | Adipate- | Adipate- |
| | Based | Based | Based | Based | Based |
| Isocyanate | MDI | MDI | MDI | MDI | MDI |
| Surface | 0.5 | 1.7 | 4.7 | 6.8 | 7.5 |
| Roughness | | | | | |
| of Mold | | | | | |
| (μm) | | | | | |
| Surface | 0.5 | 1.7 | 4.5 | 6.5 | 7.5 |
| Roughness | | | | | |
| of Stopper | | | | | |
| (μm) | | | | | |
| Mold | C1 | A1 | A1 | A1 | C1 |
| Releasability | | | | | |
| Adhesion | 0.83 | 0.77 | 0.65 | 0.50 | 0.41 |
| Torque | | | | | |
| (mNm) | | | | | |
| Hardness | 95 | 95 | 95 | 95 | 95 |
| Compression | 40 | 40 | 40 | 40 | 40 |
| Set (%) | | | | | |
| Modulus of | 37 | 37 | 37 | 37 | 37 |
| Repulsion | | | | | |
| Elasticity | | | | | |
| (%) | | | | | |
| Quantity of | 80 | 80 | 80 | 80 | 80 |
| Generation | | | | | |
| of Outgas | | | | | |
| (ppm) | | | | | |

As shown in Table 1, the surface roughness values Rz of the stoppers were close to those of the molds. Thus, it has been understood that a stopper having desired surface roughness can be obtained by controlling the surface roughness of a mold.

While the surface roughness values Rz of the stoppers according to comparative examples 1 and 2 were less than 1 μm and in excess of 6.5 μm respectively, those of the stoppers according to Examples 1 to 3 were at least 1 μm and not more than 6.5 μm. Therefore, the stoppers according to Examples 1 to 3 were superior in mold releasability to those according to comparative examples 1 and 2, and detachable from the molds without breaking the irregularities.

While the surface roughness Rz of the stopper according to comparative example 1 was less than 1 μm, those of the stoppers according to Examples 1 to 3 were at least 1 μm and not more than 6.5 μm. Therefore, the adhesion torque values of the stoppers according to Examples 1 to 3 were lower than that of the stopper according to comparative example 1. When the stoppers according to Examples 1 to 3 are employed, therefore, arms can be smoothly returned to original positions when data are completely recorded or reproduced.

### Examples 2 and 4 and Comparative Examples 3 to 5

Stoppers according to Example 4 and comparative examples 3 to 5 were prepared according to the method described in the aforementioned <Preparation of Stopper> with reference to Examples 1 to 3 and comparative examples 1 and 2, except that materials shown in Table 2 were employed. Thereafter surface roughness values, hardness values, compression sets, moduli of repulsion elasticity and quantities of generation of outgases in the stoppers were examined according to the methods described in the aforementioned <Examples 1 to 3 and Comparative Examples 1 and 2>. Further, moldability values of the stoppers were examined as follows:

<Evaluation of Moldability>

The time for cooling performed when detaching each of molded stoppers from a mold was varied to examine the presence or absence of deformation of the stopper detached from the mold. Referring to “Moldability” in Table 2, “A2” denotes that the stoppers remained undeformed when the cooling time was set to less than 30 seconds, “B2” denotes that the stopper remained undeformed when the cooling time was set to at least 30 seconds and less than 40 seconds, and “C2” denotes that the stoppers could not be prevented from deformation unless the cooling time was set to at least 40 seconds.

TABLE 2

| | | | Comparative | Comparative | Comparative |
|---|---|---|---|---|---|
| | Example 2 | Example 4 | Example 3 | Example 4 | Example 5 |
| Polyol | Adipate-Based | Caprolactone-Based | Ether-Based | Caprolactone-Based | Carbonate-Based |
| Isocyanate | MDI | MDI | MDI | TODI | TODI |
| Surface | 4.7 | 4.7 | 4.7 | 4.7 | 4.7 |
| Roughness | | | | | |
| of Mold | | | | | |
| (μm) | | | | | |
| Surface | 4.5 | 4.5 | 4.5 | 4.5 | 4.5 |
| Roughness | | | | | |
| of Stopper | | | | | |
| (μm) | | | | | |
| Moldability | A2 | A2 | C2 | C2 | B2 |
| Hardness | 95 | 94 | 95 | 94 | 94 |
| Compression | 40 | 40 | 45 | 25 | 25 |
| Set (%) | | | | | |
| Modulus of | 37 | 40 | 40 | 35 | 25 |
| Repulsion | | | | | |
| Elasticity | | | | | |
| (%) | | | | | |
| Quantity of | 80 | 110 | 120 | 250 | 300 |
| Generation | | | | | |
| of Outgas | | | | | |
| (ppm) | | | | | |

As shown in Table 2, polyol was prepared from adipate-based polyol, while diisocyanate was prepared from MDI in Example 2. In comparative example 3, on the other hand, diisocyanate was prepared from MDI, while polyol was prepared from ether-based polyol. In comparative example 4, polyol was prepared from caprolactone-based polyol, while diisocyanate was prepared from TODI (3,3′-dimethyl-4,4′-biphenyl diisocyanate). In comparative example 5, polyol was prepared from carbonate-based polyol, while diisocyanate was prepared from TODI. Therefore, the materials for the polyurethane-based elastomer composition of the stopper according to Example 2 were superior in strength/physical properties to those for the polyurethane-based elastomer compositions of the stoppers according to comparative examples 3 to 5. Thus, the stopper according to Example 2 was superior in moldability to those according to comparative examples 3 to 5.

Also in the stopper according to Example 4, diisocyanate was prepared from MDI. Therefore, the stopper according to Example 4 was superior in moldability to those according to comparative examples 3 to 5.

Further, the stoppers according to Examples 2 and 4 were so excellent in moldability that no addition of mold release agent was required, and hence it was possible to suppress the quantities of generation of outgases to less than 120 ppm.

### Examples 2, 5 and 6

Stoppers according to Examples 5 and 6 were prepared according to the method described in the aforementioned <Preparation of Stopper> with reference to Examples 1 to 3 and comparative examples 1 and 2, except that at least either loadings of polyol or those of diisocyanate were changed so that hardness values of the stoppers were different from each other. Thereafter surface roughness values, moldability values, hardness values, compression sets, moduli of repulsion elasticity and quantities of generation of outgases in the stoppers were examined according to the methods described in the aforementioned <Examples 2 and 4 and Comparative Examples 3 to 5>.

TABLE 3

| | Example 5 | Example 2 | Example 6 |
|---|---|---|---|
| Polyol | Adipate- | Adipate- | Adipate- |
| | Based | Based | Based |
| Isocyanate | MDI | MDI | MDI |
| Surface Roughness of Mold (μm) | 4.7 | 4.7 | 4.7 |
| Surface Roughness of Stopper (μm) | 4.5 | 4.5 | 4.5 |
| Moldability | A2 | A2 | A2 |
| Hardness | 92 | 95 | 98 |
| Compression Set (%) | 40 | 40 | 40 |
| Modulus of Repulsion Elasticity (%) | 40 | 37 | 35 |
| Quantity of Generation of Outgas | 90 | 80 | 80 |
| (ppm) | | | |

As shown in Table 3, it has been understood that a stopper exhibiting excellent moldability and having a prescribed compression set and a prescribed modulus of repulsion elasticity can be provided when hardness is at least 92 and not more than 98.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A stopper for a magnetic head, coming into contact with a locking portion formed on an arm having a magnetic head, having surface roughness (Rz) of at least 1 μm and not more than 6.5 μm, and made of a polyurethane-based elastomer composition.

2. The stopper for a magnetic head according to claim 1, wherein
said polyurethane-based elastomer composition contains a polyurethane elastomer consisting of diisocyanate and adipate-based polyol.

3. The stopper for a magnetic head according to claim 1, wherein
said polyurethane-based elastomer composition has JIS-A hardness of 90 to 98.
